(19) United States
(12) Patent Application Publication
(10) Pub. No.: US 2007/0154742 A1
(43) Pub. Date: Jul. 5, 2007

(54) Starting up and shutting down a fuel cell

(76) Inventors: Hao Tang, Montreal (CA); Zhigang Qi, Albany, NY (US); Manikandan Ramani, Watervliet, NY (US); Kenneth M. Rush, Clifton Park, NY (US); Lam F. Wong, Waterford, NY (US); Noel Miklas, Gansevoort, NY (US)

Correspondence Address: TROP PRUNER & HU, PC, 1616 S. VOSS ROAD, SUITE 750, HOUSTON, TX, 77057-2631, US

(21) Appl. No.: 11/321,885

(22) Filed: Dec. 29, 2005

(51) Int. Cl. H01M 8/04

(52) U.S. Cl. 429/13; 429/22

(57) ABSTRACT

A technique to shut down a fuel cell stack includes reducing an oxidant flow through the fuel cell stack, and decreasing the current of the fuel cell stack while maintaining an approximately constant rate of fuel flow to the fuel cell stack. Once the power output of the fuel cell stack reaches zero due to the depletion of oxygen at the cathode, the fuel flow to the fuel cell stack anode is then halted. Then, the stack is either isolated from the reactant streams, or the cathode is briefly purged by the fuel before the stack is isolated from the reactant streams, or both the anode and the cathode are purged in sequence by air before the stack is isolated from the reactant streams.

### BACKGROUND

The invention generally relates to starting up and shutting down a fuel cell system and more particularly relates to shutting down and starting up a fuel cell, which may be operated either in a forward power producing mode or in a reverse mode in which the fuel cell functions as an electrolyzer.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the room temperature to 90° Celsius (C) temperature range. Another type employs a phosphoric-acid-based polybenziamidazole, PBI, membrane that operates in the 150° to 200° temperature range. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:
Anode: H₂→2H⁺+2e⁻ Equation 1
Cathode: O₂+4H⁺+4e⁻→2H₂O Equation 2

The PEM fuel cell is only one type of fuel cell. Other types of fuel cells include direct methanol fuel cells, alkaline fuel cells, phosphoric acid fuel cells, molten carbonate fuel cells, and solid oxide fuel cells.

The above-described operation of the fuel cell is for the case in which the fuel cell is operating in its traditional sense, i.e., in its forward operational mode in which the fuel cell produces power. However, the fuel cell may be operated in a reverse mode in which the fuel cell produces hydrogen and oxygen from electricity and water. More specifically, an electrolyzer splits water into hydrogen and oxygen with the following reactions occurring at the anode and cathode, respectively:
Anode: 2H₂O→O₂+4H⁺+4e⁻ Equation 3
Cathode: 4H⁺+4e⁻→2H₂ Equation 4

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one cell of the stack. The plates may include various surface flow channels and orifices to, as examples, route the reactants and products through the fuel cell stack. Electrically conductive gas diffusion layers (GDLs) may be located on each side of a catalyzed PEM to form the anode and cathodes of each fuel cell. In this manner, reactant gases from both the anode and cathode flow-fields may diffuse through the GDLs to reach the catalyst layers.

The fuel cell stack is one out of many components of a typical fuel cell system, as the fuel cell system may include a cooling subsystem, a cell voltage monitoring subsystem, a control subsystem, a power conditioning subsystem, etc. The particular design of each of these subsystems is a function of the application that the fuel cell system serves.

Care must be exercised in shutting down and starting up a fuel cell stack for such purposes of preventing chemical combustion; preventing damage to the membranes of the fuel cell stack; and preventing corrosion/oxidation of components, such as preventing the corrosion of the cathode electrode.

Thus, there exists a continuing need for better ways to start up and shut down a fuel cell.

### SUMMARY

In an embodiment of the invention, a technique to shut down a fuel cell stack includes reducing an oxidant flow through the fuel cell stack, and decreasing the current of the fuel cell stack while maintaining an approximately constant rate of fuel flow to the fuel cell stack. Once the power output of the fuel cell stack reaches zero due to the depletion of oxygen at the cathode, the fuel flow to the fuel cell stack anode is then halted. Then, the stack is either isolated from the reactant streams, or the cathode is briefly purged by the fuel before the stack is isolated from the reactant streams, or the anode and the cathode are sequentially purged (i.e., the anode is purged before the cathode) by air before the stack is isolated from the reactant streams.

In another embodiment of the invention, a technique to start up a fuel cell stack includes providing fuel flows to both anode and cathode chambers of the fuel cell stack in such a controlled fashion that the active area covered by the fuel in the anode overlaps with that in the cathode and subsequently replacing the fuel flow to the cathode chamber with an oxidant flow if the stack shutdown steps include purging both the anode and cathode with air as the final step. If the final shutdown step does not include purging both the anode and cathode with air, the fuel cell will be started by letting the fuel to the anode first, and then air to the cathode.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIGS. 2, 3, 6, 7, 9, 10A and 10B are flow diagrams depicting techniques to shut down a fuel cell system according to different embodiments of the invention.

FIGS. 4 and 5 are flow diagrams depicting different techniques to start up a fuel cell system according to different embodiments of the invention.

FIG. 8 depicts polarization curves showing advantages of communicating fuel to the cathode chamber of the fuel cell during the start up or shut down of the fuel cell according to an embodiment of the invention.

### DETAILED DESCRIPTION

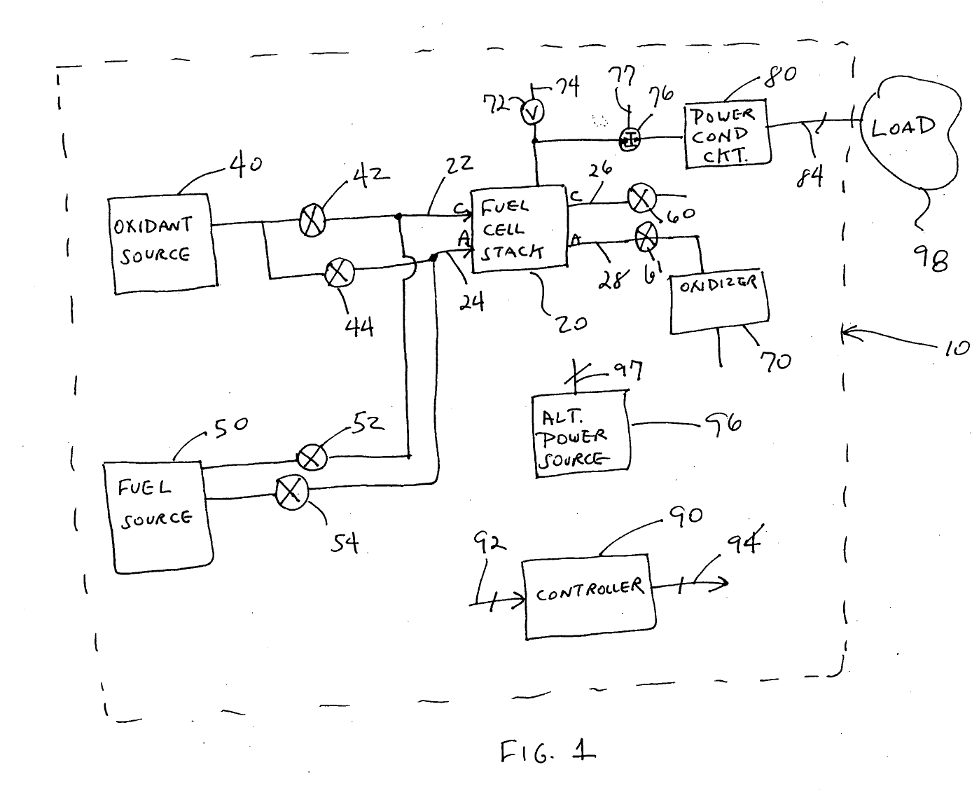

In accordance with embodiments of the invention disclosed herein, several techniques are disclosed for purposes of shutting down and starting up a fuel cell, such as a fuel cell of a fuel cell stack 20, which is depicted in FIG. 1.

Referring to FIG. 1, in accordance with an embodiment of the invention, the fuel cell stack 20 is part of a fuel cell system 10. In accordance with some embodiments of the invention, the fuel cell stack 20 produces electrical power for an external load 98 to the fuel cell system 10. Depending on the particular embodiment of the invention, the fuel cell system 10 may provide either an AC voltage or a DC voltage for the load 98. The fuel cell stack 20 produces the electrical power in response to fuel and oxidant flows that are furnished by a fuel source 50 and an oxidant source 40, respectively. As more specific examples, the fuel source 50 may be a reformer or a hydrogen tank (as just a few examples). The oxidant source 40 may be an air blower (for example), in accordance with some embodiments of the invention.

Although the fuel cell stack 20 is discussed herein as operating in its forward mode of operation in which the fuel cell stack 20 produces electrical power, it is noted that the fuel cell stack 20 may be operated in its reverse mode of operation in accordance with other embodiments of the invention. In this regard, the fuel cell stack 20 may also be operated as an electrolyzer in which the fuel cell stack produces hydrogen and oxygen (see Equations 3 and 4) in response to electricity and water. Thus, many variations are possible from the embodiments that are described herein and are within the scope of the appended claims.

During its normal course of operation (i.e., when not being started up or shut down), the fuel cell stack 20 receives the fuel flow from the fuel source 50 into its anode inlet 24 and receives the oxidant flow from the oxidant source 40 into its cathode inlet 22. The incoming fuel to the fuel cell stack 20 flows through the anode chamber of the stack and exits the anode chamber at an anode exhaust outlet 28. In the context of this application, the “anode chamber” of the fuel cell stack 20 refers to the anode input plenum, the anode flow channels and the anode output plenum of the stack 20. The incoming to the fuel cell stack flows from the cathode inlet 22 into the cathode chamber of the fuel cell stack 20 and exits the stack 20 at a cathode exhaust outlet 26. In the context of this application, the “cathode chamber” refers to the cathode input plenum, the cathode flow channels and the cathode output plenum of the fuel cell stack 20.

As depicted in FIG. 1, in accordance with some embodiments of the invention, the anode exhaust outlet 28 may be connected to an oxidizer 70 for purposes of reducing emissions from the stack 20. The cathode exhaust may be vented to ambient, may be sent to the oxidizer 70 or may be recirculated, depending on the particular embodiment of the invention.

Although FIG. 1 does not depict an anode recirculation path or a cathode recirculation path, one or more of these paths may be present in the fuel cell system in accordance with other embodiments of the invention. Furthermore, in accordance with other embodiments of the invention, the anode chamber of the fuel cell stack may be closed so that the stack is “dead-headed.” Thus, many variations of the fuel cell system are possible and are within the scope of the appended claims.

Among the other features of the fuel cell system 10, the system 10 may include power conditioning circuitry 80 that is electrically coupled to the fuel cell stack 20 for purposes of conditioning the power that is provided by the fuel cell stack into the appropriate form for the load 98. As depicted in FIG. 1, the power conditioning circuitry 80 may include output terminals 84 that are coupled to the external load 98. For applications in which the load 98 is a DC load, the power conditioning circuitry 80 may, during the normal course of operation of the fuel cell system 10, transform the DC stack voltage that is provided by the fuel cell stack 20 into the appropriate DC level for the load 98: For applications in which the load 98 is an AC load, the power conditioning circuitry may include an inverter for purposes of converting the DC stack voltage into the appropriate AC voltage for the load 98. Thus, many variations are possible and are within the scope of the appended claims.

For purposes of controlling the fuel cell system 10 and controlling the start up and shut down techniques that are described herein, the fuel cell system 10 includes a controller 90, which may include one or more microprocessors and/or microcontrollers. The controller 90 includes input terminals 92 that receive various status signals, command signals, etc., from components of the fuel cell system 10. As a more specific example, the input terminals 92 of the controller 90 may receive a signal from a voltage sensor 72 that senses the DC stack voltage and provides an indication of the DC stack voltage at its output terminal 74. As another example, the input terminals 92 of the controller 90 may receive a signal indicative of the stack current from a current sensor 76 that provides an indication of the sensed current via its output terminal 77. The controller 90 also includes output terminals 94 that furnish signals that are provided by the controller 90 for purposes of communicating commands, communicating status information and controlling various components of the fuel cell system 10. For example, the output signals that are provided on the output terminals 94 may control various valves, motors, switches, etc., of the fuel cell system 10.

The controller 90 forms part of a control subsystem to control the start up and shut down of the fuel cell system 10. In this regard, this control subsystem of the fuel cell system 10 may also include the various valves and sensors that are disclosed below for purposes of controlling the start up and shut down of the fuel cell system 10.

The fuel cell system 10 includes valves for purposes of controlling the communication of oxidant and fuel flows to and from the fuel cell stack 20. It is noted that some of the valves that are described herein and depicted in FIG. 1 may not be needed in accordance with some of the shut down and start up techniques that are disclosed herein. The valves include valves 42 and 44 that control communication of oxidant from the oxidant source 40 to the cathode 22 and anode 24 inlets of the fuel cell stack 20. The valves also include valves 52 and 54 that control the communication of fuel from the fuel source 50 to the cathode 22 and anode 24 inlets of the fuel cell stack 20. Additionally, the valves include valves 60 and 61 that control the communication of cathode and anode exhaust, respectively, from the cathode 26 and anode 28 outlets of the fuel cell stack 20. It is noted that during the normal operation of the fuel cell system 10, the valves 42, 54, 60 and 61 are open; and the valves 44 and 52 are closed. Thus, in this configuration, an oxidant flow from the oxidant source 40 through the cathode chamber of the fuel cell stack 20 is established; and a fuel flow from the fuel source 50 through the anode chamber of the fuel cell stack 20 is established.

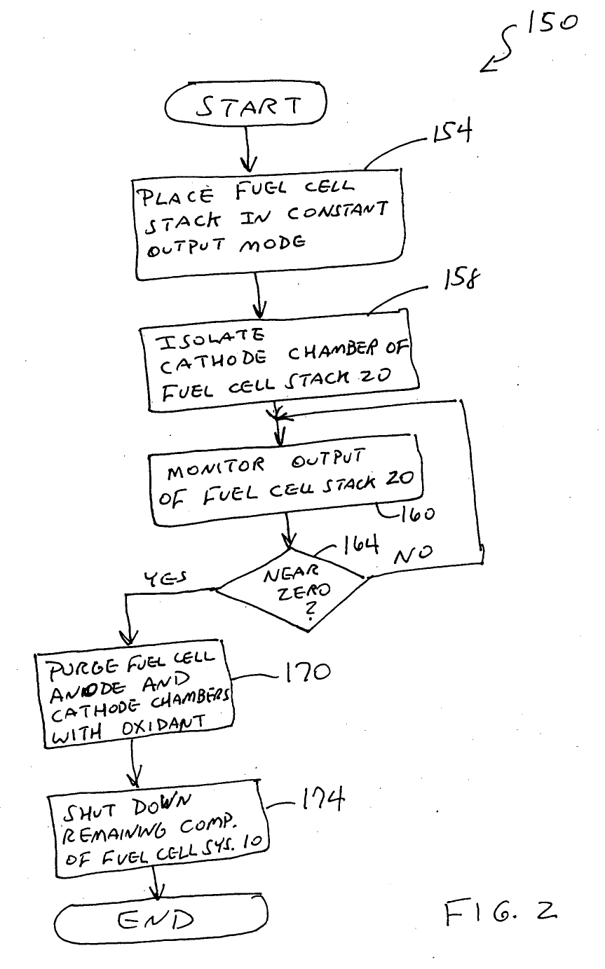

Referring to FIG. 2 in conjunction with FIG. 1, in accordance with some embodiments of the invention, the controller 90 performs a technique 150 for purposes of shutting down the fuel cell system 10. Pursuant to the technique 150, the controller 90 places (block 154) the fuel cell stack 20 in a constant output mode. In this regard, the “constant output mode” refers to either a constant voltage mode (where the stack fuel cell stack 20 provides a constant DC stack voltage), a constant current mode (in which the fuel cell stack 20 provides a constant output current) or a constant power mode (in which the fuel cell stack 20 provides a constant output power). It is noted that control of the fuel cell stack 20 so that the stack 20 produces a constant output may be achieved via the control of the power conditioning circuitry 80. For example, a DC-to-DC regulator of the power conditioning circuitry 80 may be controlled for purposes of regulating the output voltage (in the constant voltage mode) of the fuel cell stack 20.

Pursuant to the technique 150, the controller 90 isolates (block 158) the cathode chamber of the fuel cell stack 20. In other words, the controller 90 closes the valves 42, 52 and 60 for purposes of closing off the communication of oxidant to the cathode chamber of the fuel cell stack 20. Next, pursuant to the technique 150, the controller 90 monitors (block 160) the output of the fuel cell stack 20. This monitoring depends on the particular mode in which the fuel cell stack 20 operates. For example, for the constant voltage mode of the stack 20, the controller 90 monitors the current (via the current sensor 76) of the stack 20. As another example, for the constant current mode, the controller 90 monitors the stack voltage (via the voltage sensor 72).

In response to determining (diamond 164) that the monitored output of the fuel cell stack 20 is near zero, then the controller 150 sequentially purges (block 170) the fuel cell anode and cathode chambers (i.e., purges the anode chamber before the cathode chamber) with oxidant and shuts down (block 174) the remaining components of the fuel cell system 10. To purge the anode and cathode chambers of the fuel cell stack 20 with oxidant, the controller 90 opens the valves 42, 44, 60 and 61 while maintaining the valves 52 and 54 closed.

The power required to perform purging and other actions after the fuel cell output power approaches zero may come from alternative power sources. In response to determining (diamond 208) that the output power of the fuel cell stack 20 is near zero, the controller 90 connects (block 210) parasitic components of the fuel cell system 10 to an alternate power source 96 (see FIG. 1). These parasitic components are the components of the fuel cell system 10 that receive power from the fuel cell stack 20 during the normal mode of operation of the fuel cell system 10. Thus, the parasitic components may include electronic components, pumps, motors, etc., that receive power from the fuel cell stack 20 for purposes of operating the fuel cell system 10. It is noted that this power may be distributed to the components via the power conditioning circuitry 80. The alternate power source 96 may be, in accordance with some embodiments of the invention, a battery that is charged with power from the fuel cell stack 20 during the normal operation of the fuel cell system 10. Alternatively, as another example, the alternate power source 96 may be formed from one or more ultracapacitors. Thus, when the controller 90 connects the alternate power source 96 to the parasitic components, the controller 90 may connect output terminals 97 of the source 96 to a power distribution system for purposes of distributing power to the parasitic components.

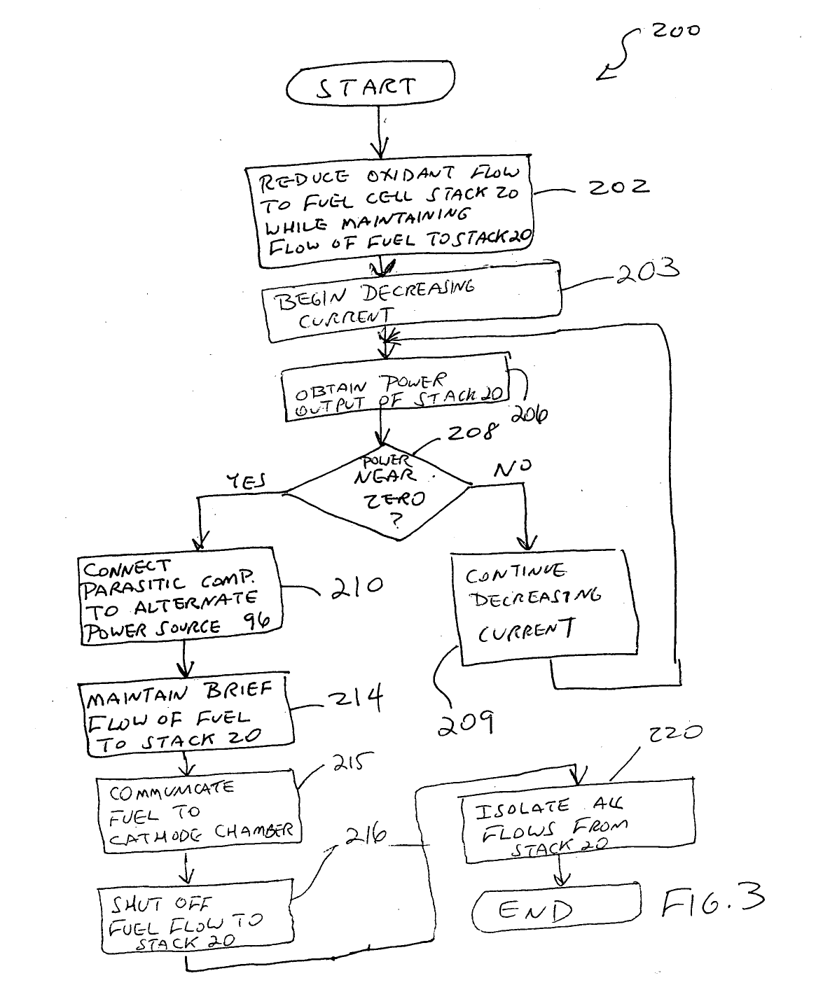

Referring to FIG. 3 in conjunction with FIG. 1, pursuant to the technique 200, the controller 90 reduces (block 202) the oxidant flow to the fuel cell stack 20 while maintaining the flow of fuel to the stack 20. Thus, the controller 90 maintains the valve 54 in the same state as in the normal operation of the fuel cell system 10 and controls the valve 42 to restrict the flow of oxidant to the fuel cell stack 20, as compared to the normal mode of operation.

Pursuant to the technique 200, the controller 90 begins (block 203) decreasing the current in the fuel cell stack 20. In this regard, in accordance with some embodiments of the invention, for purposes of controlling and decreasing the fuel cell stack current, the controller 90 controls the power conditioning circuit 80 to progressively decrease the current that flows from the fuel cell stack terminal and thus, from the fuel cell stack 20. It is noted that this decrease may a linear decrease or another form of decrease, depending on the particular embodiment of the invention.

As the current from the fuel cell stack 20 is decreasing, the controller 90 obtains (block 206) the power output of the stack 20. As an example, the controller 90 may obtain the power output by obtaining the stack voltage (via the voltage sensor 72) and stack current (via the current sensor 76) and calculating the power output of the fuel cell stack 20 from these measurements. In response to determining (diamond 208) that the power output of the stack 20 is not near zero, the controller 90 continues decreasing the stack current, as depicted in block 209; and control returns to block 206.

After maintaining (block 214) a brief flow of fuel to the fuel cell stack 20 after the output power of the fuel cell stack 20 reaches zero, the controller 90 starts to communicate fuel to the cathode chamber of the stack 20 by briefly opening the valve 52, before the controller 90 shuts off the fuel flow to the stack 20, pursuant to block 216. Next, pursuant to the technique 200, the controller 90 isolates (block 220) the rest of the streams from the fuel cell stack 20. In this regard, pursuant to block 220, the controller 90 ensures that the valves 42, 44, 52, 54, 60 and 61 are closed. Additionally, in accordance with some embodiments of the invention, the controller 90 may also shut off any coolant flow from a coolant subsystem (not depicted in FIG. 1) to the fuel cell stack 20.

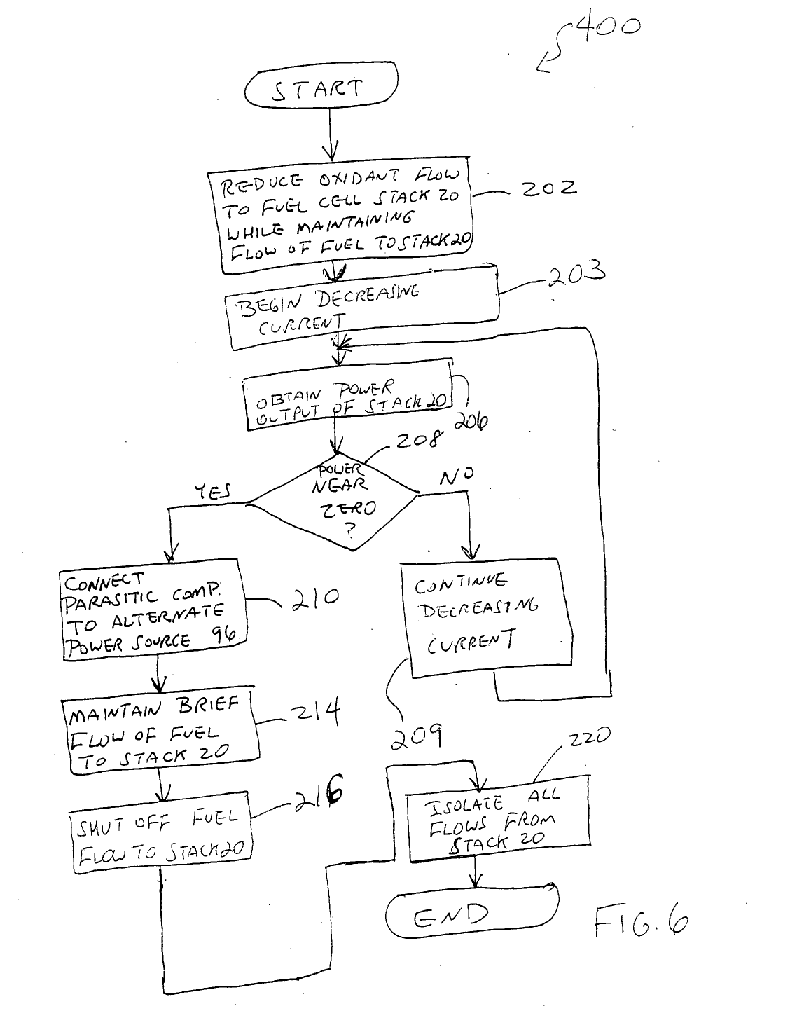

Alternatively, the controller 90 may perform a technique 400 (see FIG. 6), which is a slight modification from the technique 200 with the following differences. Pursuant to the technique 400, after maintaining the brief flow of fuel to the stack 20 (block 214), the controller 90 shuts off (block 216) flow to the fuel cell stack 20. Subsequently, the controller 90 isolates (block 220) all flows from the fuel cell stack 20.

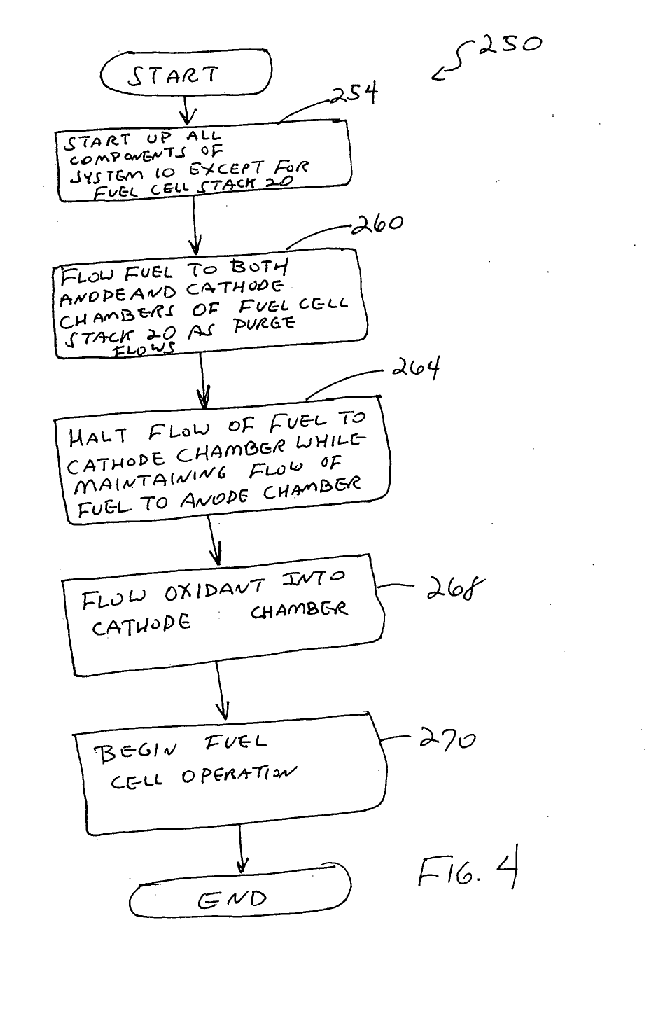

Referring to FIG. 4, in conjunction with FIG. 1, in accordance with some embodiments of the invention, the controller may perform a technique 250 for purposes of starting up the fuel cell system 10. It is assumed that prior to the beginning of the technique 250, anode and cathode chambers of the fuel cell stack 20 are filled with oxidant. The fuel cell stack 10 may have been shut down pursuant to the technique 150 that is depicted in FIG. 2, for example.

Pursuant to the technique 250, the controller 90 starts up all components of the fuel cell system 10 except for the fuel cell stack 20, as depicted in block 254. Next, the controller 90 causes fuel to flow into both the anode and cathode chambers of the fuel cell stack 20, pursuant to block 260. In other words, by allowing fuel to flow into both the anode and cathode chambers, fuel is used as the purge flow. Thus, pursuant to block 260, the controller 90 opens the valves 52, 54, 60 and 61 while maintaining the valves 42 and 44 closed. The controller 90 accurately controls the fuel flow rate to the anode and cathode chambers according to the total volumes of the flow channels and plenum passageways so that the membrane areas that are covered by the incoming fuel flow overlap and thus, are always the same for both the anode and cathode chambers. The purging of the anode and cathode chambers via the fuel flow occurs in a very short time period (a time period of only a few minutes, in accordance with some embodiments of the invention, for example).

After the purging of the anode and cathode chambers with the fuel flows, the controller 90, pursuant to the technique 250, halts (block 264) the flow of fuel to the cathode chamber while maintaining the flow of fuel to the anode chamber. Therefore, pursuant to block 264, the controller 90 closes the valve 52 while maintaining the valve 54 open. Next, the controller 90 flows oxidant into the cathode chamber of the fuel cell stack 20, pursuant to block 268. To perform this function, the controller 90 opens the valve 42. Subsequently, the controller 90 begins the normal mode of fuel cell operation, pursuant to block 270.

Because the fuel flows into the anode and cathode chambers at the same time and occupies the same areas in the anode and cathode chambers during the purging of the fuel cell stack, carbon corrosion is inhibited.

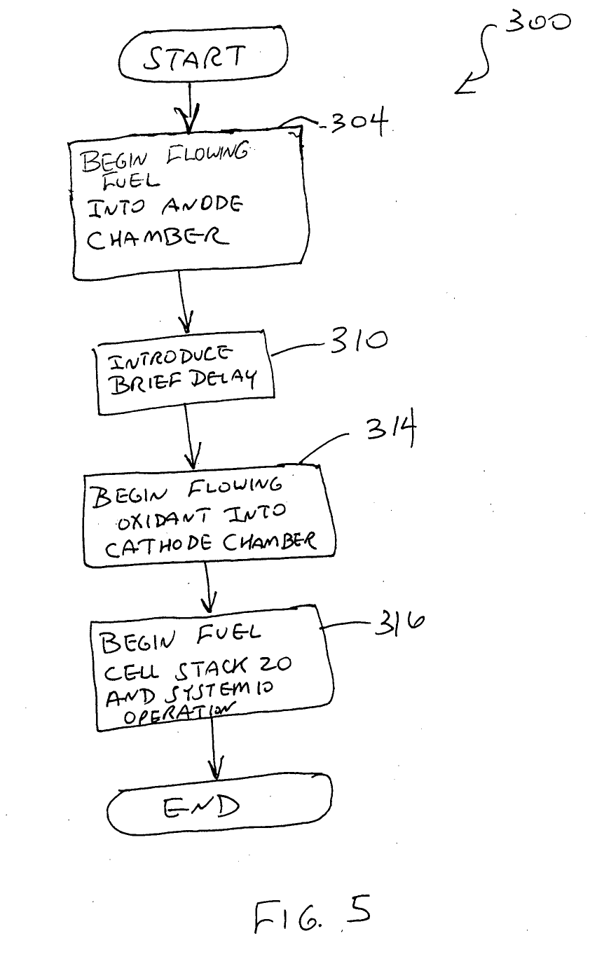

Referring to FIG. 5 in conjunction with FIG. 1, in accordance with some embodiments of the invention, the controller 90 may perform a technique 300 to start up the fuel cell system 10 when the fuel cell system 10 has been shut down pursuant to the technique 200 (see FIG. 3) or the technique 400 (see FIG. 6). It is assumed that fuel is in the anode chamber of the fuel cell stack and either fuel (according to technique 200) or oxygen-depleted air (according to technique 400) is in the cathode chamber. Pursuant to the technique 300, the controller 90 causes fuel to begin flowing into the anode chamber, pursuant to block 304. Thus, pursuant to block 304, the controller 90 ensures that the valves 54 and 61 are opened while maintaining the valves 42, 44, 60, and 52 closed. Next, the controller 90 introduces a brief delay (a delay less than a minute, for example), pursuant to block 310 to permit the fuel to flow through the anode chamber for this brief time. Subsequently, the controller 90 causes oxidant to begin flowing into the cathode chamber, pursuant to block 314. Therefore, at this point, the controller 90 controls the valves of the fuel cell system 10 by opening the valve 42 and valve 60, keeping the valve 44 and the valve 52 closed, maintaining the valve 54 open and maintaining the valve 61 open. Subsequently, the controller 90 begins (block 316) the normal mode of fuel cell stack operation.

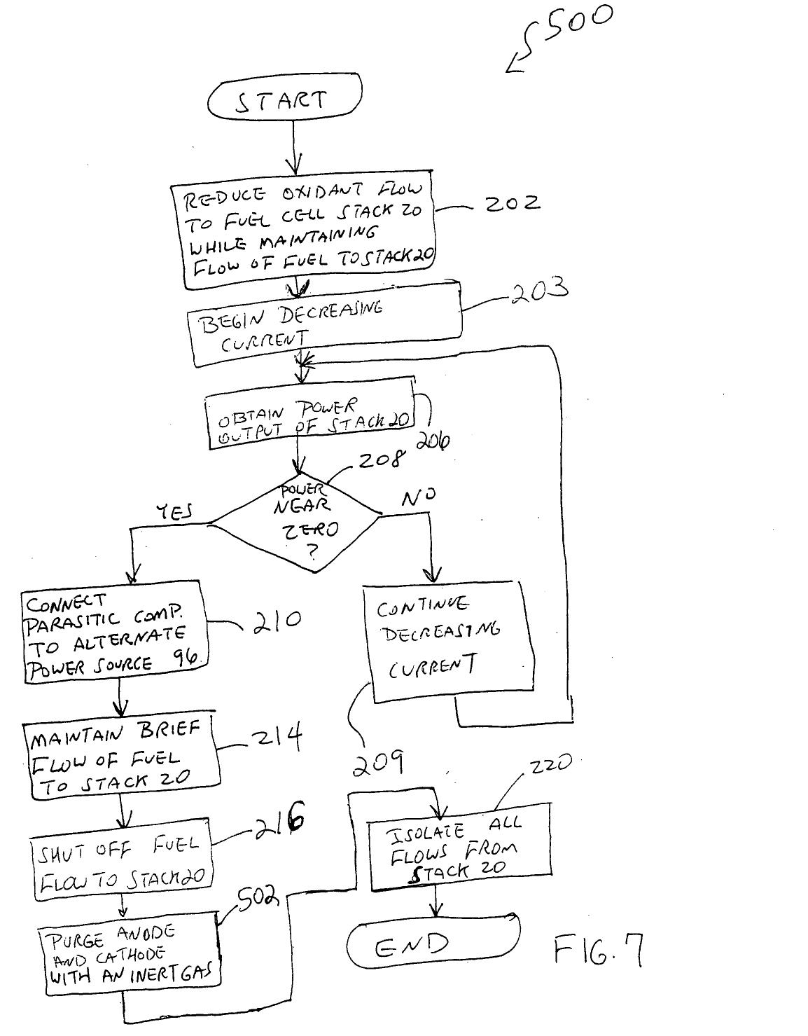

Many variations are possible and are within the scope of the appended claims. For example, referring to FIG. 7, a technique 500 may be used for purposes of shutting down the fuel cell stack 20 in accordance with other embodiments of the invention. The technique 500 is similar to the technique 200 (FIG. 3), with like reference numerals being used, with the following differences. In particular, in the technique 500, after the controller 90 shuts off fuel flow to the fuel cell stack 20 pursuant to block 216, the controller 90 then operates the valves to purge the anode and cathode chambers of the fuel cell stack 20 with an inert gas flow, pursuant to block 502. The inert gas may be Nitrogen, in accordance with some embodiments of the invention. Subsequently, the controller 90 isolates (block 220) all flows from the fuel cell stack 20.

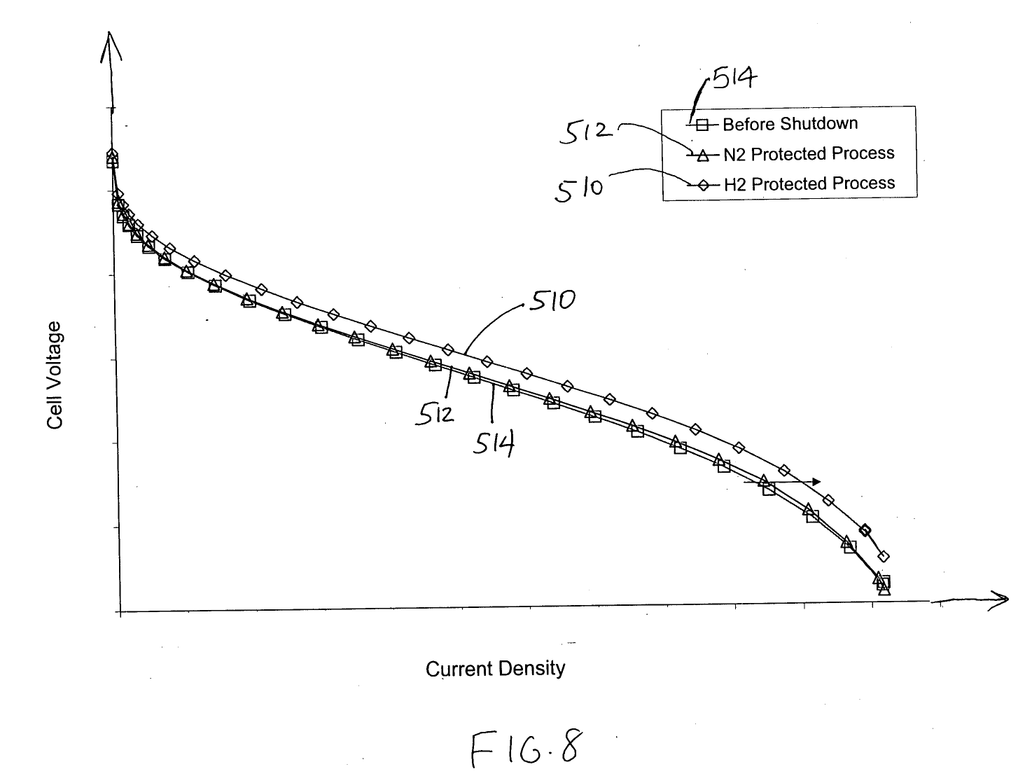

Thus, the shut down techniques 200 (FIG. 3), and 500 (FIG. 7) all include communicating fuel to the cathode chamber of the fuel cell during its shut down. It has been discovered that the communication of fuel to the cathode of the fuel cell during the shut down or restart process has certain advantages. FIG. 8 depicts polarization curves 510, 512 and 514 that illustrate differences between the use of an inert gas, such as nitrogen to protect the start up and shut down of the fuel cell and the use of hydrogen to protect the fuel cell during the start up and shut down process. More particularly, the polarization curve 514 depicts the fuel cell performance before the fuel cell was shut down, and the polarization curve 512 depicts the fuel cell performance after the cell went through one shut down restart cycle under the protection of nitrogen. After the shut down, the fuel cell was allowed to cool down to room temperature and then was re-heated up to 50° C. This process took about one hour and nitrogen was conducted to both the anode and cathode chambers in the entire process. After the cell reached 50° C., hydrogen and air were fed into the anode and cathode chambers, respectively. When the cell reached a stable performance, the polarization curve 512 was taken. As can be seen from a comparison between the polarization curves 512 and 514, the performance was similar to that before the shut down.

The polarization curve 510 depicts the fuel cell performance after the cell went through one shut down and restart cycle under the protection of hydrogen. The process was similar to the nitrogen protected process, except that nitrogen was replaced by hydrogen. As can be seen from a comparison of the polarization curves 510 and 514, the fuel cell has a much better performance than it did before the shut down.

The performance improvement under the protection of hydrogen is believed to be due to the reduction of PtOₓ to Pt at the cathode through the following reaction:
PtOₓ+xH₂→Pt+xH₂O, Equation 5

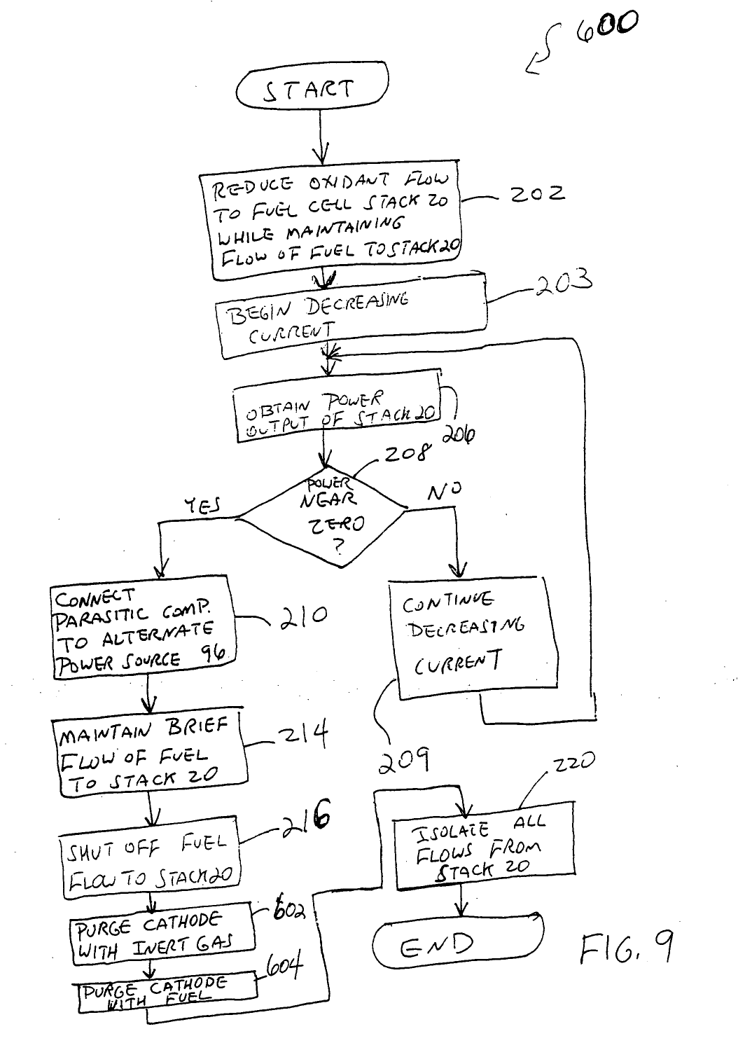

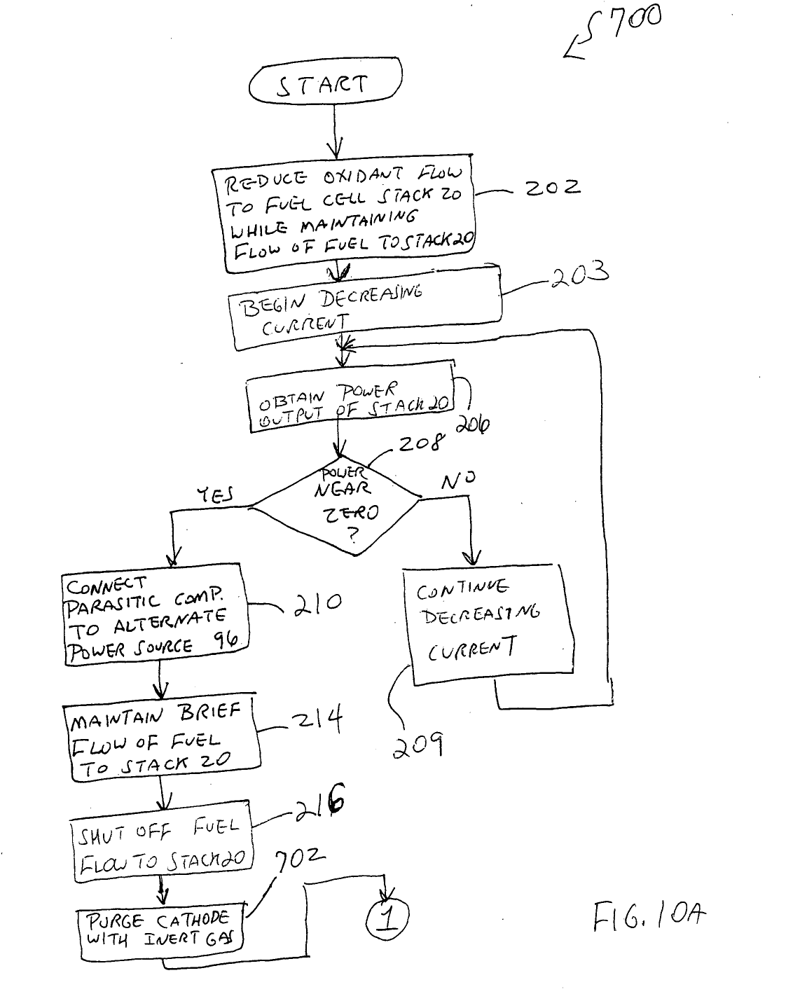

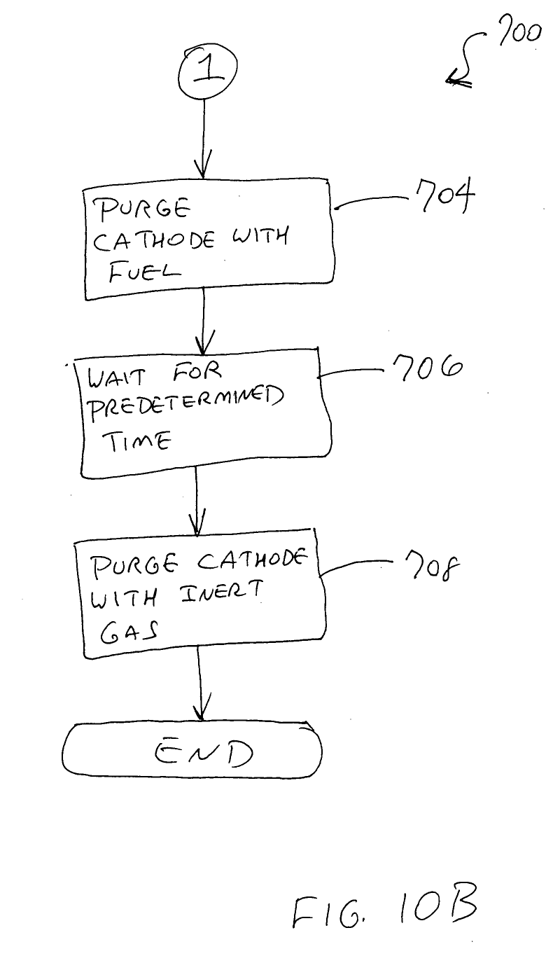

FIGS. 9, 10A and 10B depict more techniques to shut down the fuel cell stack, which purge the cathode with fuel during the shut down process. More specifically, FIG. 9 depicts a technique 600 that is similar to the technique 200 (FIG. 3) with like reference numerals being used with the following differences. In particular, pursuant to the technique 600, after the fuel flow to the stack 20 is shut off (block 216) the cathode is purged with inert gas (such as Nitrogen, for example), pursuant to block 602. Subsequently, the cathode chamber is purged with fuel, pursuant to block 604. Then all flows are isolated from the stack 20, as depicted in block 220.

FIGS. 10A and 10B depict a technique 700 similar to the technique 200 (see FIG. 3) to shut down a fuel cell stack with like references being used, except for the following differences. Similar to the technique 600 (FIG. 9), the technique 700 includes purging the cathode chamber of the fuel cell stack with an inert gas (Nitrogen, for example, as depicted in block 702) after the fuel flow is shut off to the stack 20, pursuant to block 216. Next, the technique 700 includes purging the cathode chamber with fuel, pursuant to block 704, also similar to the technique 600. However, subsequently, after waiting for a predetermined time (block 706) the technique 700 includes purging the cathode chamber with inert gas again, as depicted in block 708.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method to shut down a fuel cell stack, comprising:
reducing an oxidant flow to the fuel cell stack;
decreasing a current of the fuel cell stack while maintaining an approximately constant rate of fuel flow to the fuel cell stack;
continuing the act of decreasing the current until a power output of the fuel cell stack is near zero;
subsequent to the decreasing, halting the fuel flow to the stack; and
purging a cathode chamber of the fuel cell stack with an inert gas after the fuel flow to the stack is halted.

2. The method of claim 1, further comprising:
in response to the power output being near zero, continuing to communicate the fuel flow to the fuel cell stack for a predetermined duration of time.

3. The method of claim 2, further comprising:
after the act of continuing to communicate the fuel flow, isolating the fuel cell stack from any flow entering the fuel cell stack.

4. The method of claim 1, further comprising:
in response to the power output being near zero, connecting a power source to components that are normally powered by the fuel cell stack for the remainder of the shut down of the fuel cell stack.

5. The method of claim 1, further comprising:
purging the cathode chamber with fuel after the purging of the cathode chamber with the inert gas.

6. The method of claim 5, further comprising:
waiting for a predetermined time after the purging of the cathode chamber with fuel and subsequently purging the cathode chamber with inert gas after the expiration of the predetermined time.

7. A method to start up a fuel cell stack having an anode chamber and a cathode chamber with different volumes, the method comprising:
providing fuel flows to the anode and cathode chambers of the fuel cell stack;
regulating the providing to accommodate the different volumes so that a membrane area that contacts fuel in the anode chamber is the same as a membrane area that contacts fuel in the cathode chamber; and
replacing the fuel flow to the cathode chamber with an oxidant flow.

8. The method of claim 7, further comprising:
beginning fuel cell operation of the fuel cell stack in response to the act of replacing.

9. The method of claim 8, wherein the act of replacing comprises:
halting the fuel flow to the fuel cell stack cathode while maintaining the fuel flow to the fuel cell stack anode.

10. A fuel cell system comprising:
a fuel cell stack; and
a control subsystem to shut down the fuel cell stack, the control subsystem adapted to:
reduce an oxidant flow to the fuel cell stack; and
decrease a current of the fuel cell stack while maintaining an approximately constant rate of fuel flow to the fuel cell stack;
continue to decrease the current until a power output of the fuel cell stack is near zero and subsequently halt the fuel flow to the fuel cell stack; and
after the halting of the fuel flow to the fuel cell stack, communicate an inert gas to a cathode chamber of the fuel cell stack to purge the cathode chamber.

11. The fuel cell system of claim 10, wherein the control subsystem is further adapted to purge the cathode chamber with fuel subsequent to the purging of the cathode chamber with the inert gas.

12. The fuel cell system of claim 11, wherein the inert gas comprises nitrogen, helium, argon, and carbon dioxide.

13. The fuel cell system of claim 11, wherein the control subsystem is further adapted to purge the cathode chamber with an inert gas again after the expiration of the predetermined time from when the cathode chamber is purged with the fuel.

14. The fuel cell system of claim 10, wherein the control subsystem is adapted to control a load of the fuel cell stack to decrease the current.

15. The fuel cell system of claim 10, wherein the fuel cell stack comprises PEM fuel cells.

16. The fuel cell system of claim 10, wherein the control subsystem is adapted to: in response to the power output being near zero, continue to communicate the fuel flow to the fuel cell stack for a predetermined duration of time.

17. The fuel cell system of claim 16, wherein the control subsystem comprises at least one valve, and the control subsystem is adapted to control said at least one valve to isolate the fuel cell stack from any flow entering the fuel cell stack in response to the expiration of the predetermined duration of time.

18. The fuel cell system of claim 10, further comprising:
system components adapted to receive power from the fuel cell stack during normal operation of the fuel cell system; and
a power source,
wherein the control subsystem is adapted to in response to the power output being near zero, connect the power source to the components for the remainder of the shut down of the fuel cell stack.

19. A fuel cell system, comprising:
a fuel cell stack comprising an anode chamber and a cathode chamber; and
a control subsystem adapted to:
provide fuel flows to the anode and cathode chambers of the fuel cell stack;
regulate the fuel flows to accommodate the different volumes of the anode and cathode chambers so that a membrane area that contacts fuel in the anode chamber is the same as a membrane area that contacts fuel in the cathode chamber; and
replace the fuel flow to the cathode chamber with an oxidant flow.

20. The fuel cell system of claim 19, further comprising:
an oxidant source; and
at least one valve to control communication between the oxidant source and the cathode chamber,
wherein the control subsystem is adapted to control said at least one valve to replace the fuel flow with the oxidant flow.

21. The fuel cell system of claim 19, further comprising:
a fuel source; and
at least one valve to control communication between the fuel source and the anode and cathode chambers,
wherein the control subsystem is adapted to control said at least one valve to provide the fuel flows to the anode and cathode chambers and replace the fuel flow with the oxidant flow.

22. The fuel cell system of claim 21, wherein the fuel source comprises a hydrogen tank.

23. The fuel cell system of claim 19, wherein the fuel source comprises a reformer.

24. The fuel cell system of claim 19, wherein the fuel cell stack comprises PEM fuel cells.
